(19) United States
(12) Patent Application Publication
(10) Pub. No.: US 2020/0242266 A1
(43) Pub. Date: Jul. 30, 2020

(54) SYSTEM AND METHOD THAT ALLOWS A MERCHANT OR MANUFACTURER TO STORE PRODUCT INFORMATION IN A PLURALITY OF SEPARATE CLOUDS

(71) Applicant: Envision Eli, LLC, Sarasota, FL (US)

(72) Inventors: Ronald L. Klein, Sarasota, FL (US); Richard Gibson, Austin, TX (US)

(73) Assignee: Envision Eli, LLC, Sarasota, FL (US)

(21) Appl. No.: 16/638,132

(22) PCT Filed: Jun. 7, 2018
(86) PCT No.: PCT/US18/36559

§ 371 Date: Feb. 10, 2020

Related U.S. Application Data
(60) Provisional application No. 62/605,358, filed on Aug. 9, 2017.

(51) Int. Cl. G06F 21/62; G06Q 30/06

(52) U.S. Cl. CPC G06F 21/6218; G06F 2221/2141; G06Q 30/0621; G06Q 30/0623

(57) ABSTRACT

A system and method that allows a merchant/manufacturer to store and enable restricted access to product information in a plurality of separate clouds is disclosed. A server is configured to enable the merchant/manufacturer to set pre-limited access rights for a specified entity to the product information, and to receive requests for product information over a communications network. The requests include data representing the pre-limited access rights accompanying a code that may be scanned by a transducer on an electronic device. Depending on the pre-limited access rights, the server retrieves the product related information from at least one of clouds and forwards the product information, as restricted by the pre-limited access rights, to the electronic device. The product information may include at least one of readable, audio and visible data.

### CROSS-REFERENCE TO RELATED APPLICATIONS

This application is a national stage filing of International Patent Application Serial No. PCT/US18/36559, filed on Jun. 7, 2018, which claims the benefit of U.S. Provisional Application Ser. No. 62/605,358 filed Aug. 9, 2017, the disclosure of which is incorporated by reference herein.

### FIELD OF THE DISCLOSURE

The present disclosure relates generally to online commerce, and more particularly, to a methodology and system for enabling a merchant and manufacturer to store consumer product information in a plurality of separate clouds with pre-limited access for different classes/types of consumers, thereby creating a controlled visual web-based product experience.

### SUMMARY OF THE DISCLOSURE

The present disclosure provides a system and method of enabling restricted access to product information stored in a plurality of clouds. In accordance with a feature of the disclosure, the method includes storing product related information in a plurality of clouds; receiving, by at least one server coupled to a communications network, a request for product related information from an electronic device, the request including data representing pre-limited access rights for a specified entity to at least some of the product related information; accessing, by the server, product related information from at least one of the plurality of clouds, the product related information restricted in accordance with the pre-limited access rights; and sending, by the server, the restricted product related information to the electronic device over the communications network.

In accordance with another feature of the disclosure, a code representing the pre-limited access rights is associated with at least some of the product information, and where the method further includes scanning the code with a transducer on the electronic device to relay the request for product information.

In accordance with yet another feature of the disclosure, the code is a barcode representing one of a public badge type and a private badge type corresponding to the pre-limited access rights.

In accordance with still another feature of the disclosure, the code is a QR code representing one of a public badge type and a private badge type corresponding to the pre-limited access rights.

In accordance with another feature of the disclosure, the plurality of clouds respectively corresponds to a private user, a public user, and an administrator.

In accordance with yet another feature of the disclosure, each of the plurality of clouds includes a corresponding database having a cloud-based database address.

In accordance with another feature of the disclosure, the pre-limited access rights are set by the administrator via an electronic device.

In accordance with still another feature of the disclosure, the product information is composed of at least one of readable, audible and video data.

In accordance with yet another feature of the disclosure, a scanned code representing a public badge type is sent to a first database address, and a scanned code representing a private badge type is sent to a second database address.

In accordance with another feature of the disclosure, there is provided a system for enabling restricted access to product information stored in a plurality of clouds. The system includes at least one database for storing product related information in a plurality of clouds and a server coupled to a communication network and having a non-transitory memory, at least one processor, and having a set of computer program instructions stored in the non-transitory memory and executable by the at least one processor. The set of computer instructions include instructions for: receiving, at the server, a request for product related information, the request including data representing pre-limited access rights for a specified entity to at least some of the product related information; accessing, by the server, product related information from at least one of the plurality of clouds, the product related information restricted in accordance with the pre-limited access rights; and sending, by the server, the restricted product related information to an electronic device over the communications network.

In accordance with the above and additional features that will become apparent hereinafter, the present disclosure will now be described with particular reference to the accompanying drawings.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and explain various principles and advantages all in accordance with the present disclosure.

FIG. 1 is a high-level block diagram of an embodiment of the present disclosure, illustrating an exemplary network of system in which the present disclosure may be implemented;

FIG. 2 is a block diagram of an exemplary electronic device, such as a personal mobile computing device, in accordance with the present disclosure;

FIG. 3 is a block diagram of an exemplary database server for implementing features of the present disclosure; and

FIG. 4 is a process flow chart depicting a method in accordance with a feature of the present disclosure;

### DETAILED DESCRIPTION

While the specification concludes with claims defining the features of the disclosure that are regarded as novel, it is believed that the disclosure will be better understood from a consideration of the following description in conjunction with the drawing figures, in which like reference numerals are carried forward. It is to be understood that the disclosed embodiments are merely exemplary of the disclosure, which can be embodied in various forms.

The present disclosure provides a system and method that allows a merchant/manufacturer to store and enable restricted access to product information in a plurality of separate clouds is disclosed. A server is configured to enable the merchant/manufacturer to set pre-limited access rights for a specified entity to the product information, and to receive requests for product information over a communications network. The requests include data representing the pre-limited access rights embodied in a code that may be scanned by a transducer on an electronic device. Depending on the pre-limited access rights, the server retrieves the product related information from at least one of clouds and forwards the product information, as restricted by the pre-limited access rights, to the electronic device. The product information may include at least one of readable, audio and visible data.

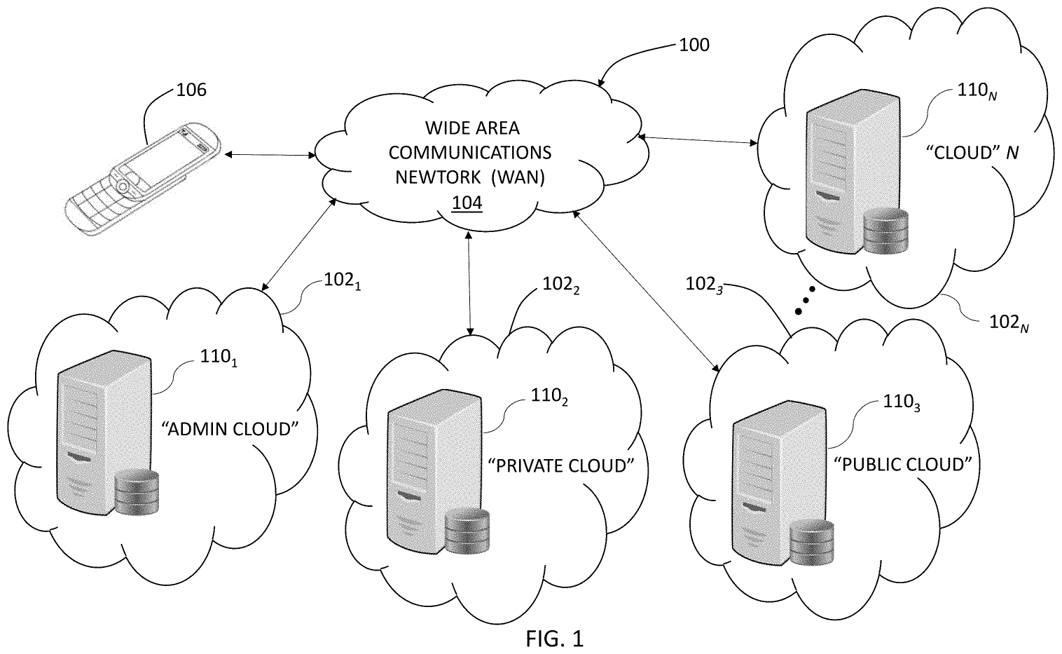

Referring now to FIG. 1, there is depicted a high-level block diagram of an embodiment of the present disclosure, illustrating an exemplary network of system in which the present disclosure may be implemented. FIG. 1 shows several advantageous features of the present disclosure, but, as will be described below, the disclosure can be implemented through various combinations of features, components and functions thereof. The example network 100 shown in FIG. 1, includes a plurality of “clouds” represented by the reference numerals 102₁, 102₂, 102₃ . . . 102_{N}, wherein the term “N” represents any number greater than 1. The clouds are communicatively coupled to a wide area communications network (WAN) generally designated by reference numeral 104 over communication links that may be established between various electronic devices and computers connected together within the network 100. The connections may be wired or wireless connections as commonly known in the art. Some exemplary wired connections are cable, phone line, and fiber optic. Exemplary wireless connections include cellular, radio frequency (RF) and infrared radiation (IR) transmission, and short-range communications protocols such as WiFi and Bluetooth, ZigBee and the like. It will be appreciated that many other wired and wireless connections as known in the art can be utilized with the present disclosure.

In the depicted example, an electronic device 106 (personal computing device such as a mobile phone) couples to the WAN 104 via a wireless connection. Although shown in FIG. 1 as a mobile phone, the electronic device 106 may encompass a tablet, laptop, PC or any other computerized device capable of communicating over a data network. The electronic device 106 is operable to execute programming instructions embodied in a software application(s) that can be downloaded from servers communicatively coupled to the WAN 104. In certain embodiments, the software application may be a web-based software application, a desktop software application, or a mobile device software application. In an example embodiment, the WAN is the Internet, which represents a worldwide collection of networks and gateways that use the TCP/IP suite of protocols to communicate with one another over a backbone of high-speed data communication lines between major nodes or host computers, consisting of thousands of commercial, government, educational and other computer systems that route data and messages. As will be understood by those skilled in the art, the WAN 106 also may be implemented as a number of different types of networks, such as for example, an Intranet, a local area network (LAN), or a cellular network(s). FIG. 1 is merely intended as an example of an operating environment, and not as an architectural limitation for the present disclosure.

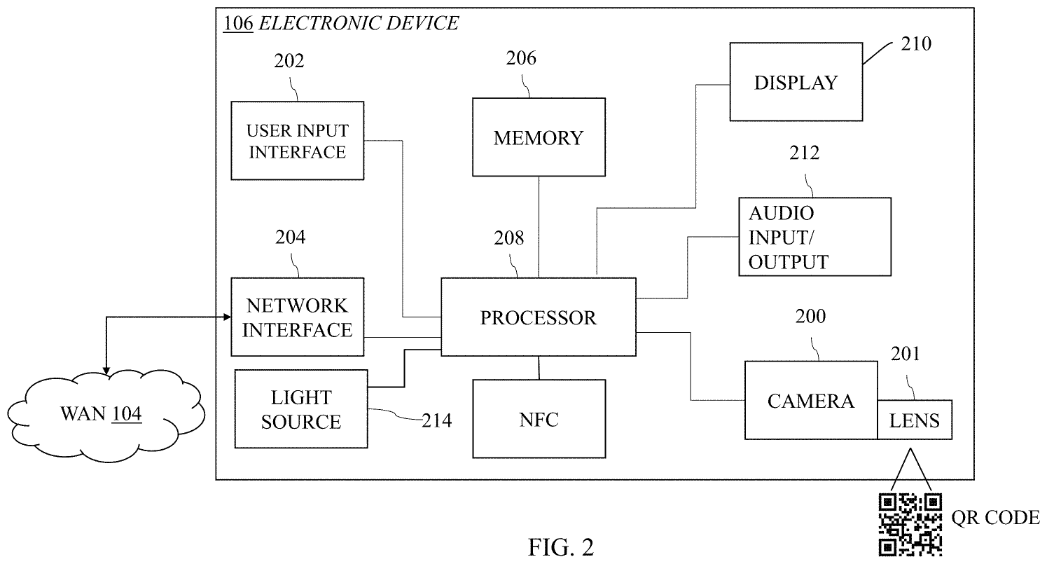

A plurality of database servers 110₁, 110₂, 110₃, . . . 110_{N} are respectively associated with each of clouds 102₁, 102₂, 103₃ . . . 102_{N} In accordance with an embodiment of the disclosure and as described in more detail below, cloud 1021 is referred to as an “administrative cloud”, cloud 102₂ is characterized as a “private cloud”, and cloud 102₃ is designated a “public cloud.” Each of the servers 110₁, 110₂, 110₃, . . . 110_{N} can be defined as a computer or computing device that manages access to a centralized resource or database. The servers 110_{1-N} can receive, process, and satisfy requests initiated by the personal electronic device 106 via the WAN 104 and may include those electrical and communication components represented in FIG. 2.

With reference now to FIG. 2, there is depicted a high-level block diagram of an example electronic device for carrying out features of the disclosure. The electronic device 106 may include a camera 200, a user input interface 202, a network interface 204, a memory 206, a processing device 208, a computer display 210, an audio input/output 212, and a light source 214. The camera 200 may include a camera lens 201 and may be operable to capture still images, as well as, video. The camera 200 is preferably a digital camera so that the images may be stored in the memory 206 and processed by the processing device 208. The camera 200 may be communicatively coupled to a microphone for capturing audio, as well as, simultaneous visual video images. In accordance with an aspect of the disclosure, the camera 200 is configured to enable scanning bar codes or QR codes via a software or hardware application resident on and executed by and/or on the electronic computing device 106. Many QR code readers for the iPhone and Android operating systems are available for download from the respective app stores for these platforms.

The user input interface 202 of the electronic computing device 106 functions to provide the user a method of providing input to the electronic device 106. The user input interface 202 may also facilitate interaction between the user and the device 106. The user input interface 202 may be a keypad providing a variety of user input operations. For example, the keypad may include alphanumeric keys for allowing entry of alphanumeric information (e.g. telephone numbers, contact information, text, etc.). The user input interface 202 may include special function keys (e.g. a camera shutter button, volume control buttons, back buttons, home button, etc.), navigation and select keys, a pointing device, and the like. Keys, buttons, and/or keypads may be implemented as a touchscreen associated with the computer display 210 of the type known in the art. The touchscreen may also provide output or feedback to the user, such as haptic feedback or orientation adjustments of the keypad according to sensor signals received by motion detectors, such as an accelerometer, located within the device 106.

The network interfaces 204 may include one or more network interface cards (NIC) or a network controller. In some embodiments, the network interface 204 may include a personal area network (PAN) interface. The PAN interface may provide the capability for the electronic device 106 to network using a short-range communication protocol, for example, a Bluetooth communication protocol. The PAN interface may permit one personal computing device 106 to connect wirelessly to another electronic device 106 via a peer-to-peer connection.

The network interfaces 204 may also include a local area network (LAN) interface. The LAN interface may be, for example, an interface to a wireless LAN, such as a Wi-Fi network. The range of the LAN interface may generally exceed the range available via the PAN interface. Typically, a connection between two electronic devices via the LAN interface may involve communication through a network router or other intermediary device.

Additionally, the network interfaces 204 may include the capability to connect to a wide area network (WAN) via a WAN interface. The WAN interface may permit a connection to, for example, a cellular mobile communications network. The WAN interface may include communications circuitry, such as an antenna coupled to a radio circuit having a transceiver for transmitting and receiving radio signals via the antenna. The radio circuit may be configured to operate in a mobile communications network, including but not limited to global systems for mobile communications (GSM), code division multiple access (CDMA), wideband CDMA (WCDMA), and the like.

The electronic device 106 may also include a near field communication (NFC) interface. The NFC interface may allow for extremely close-range communication at relatively low data rates (e.g., 424 kb/s). The NFC interface may take place via magnetic field induction, allowing the NFC interface to communicate with other NFC interfaces located on other mobile computing devices 106 or to retrieve information from tags having radio frequency identification (RFID) circuitry. The NFC interface may enable initiation and/or facilitation of data transfer from one personal computing device 106 to another computing device with an extremely close range (e.g. 4 centimeters). Such devices may be utilized to read the codes associated with RFID tags having information encoded therein to implement features of the present disclosure.

Memory 206 associated with the electronic device 106 may be, for example, one or more buffer, a flash memory, or non-volatile memory, such as random-access memory (RAM). The electronic device 106 may also include non-volatile storage. The non-volatile storage may represent any suitable storage medium, such as a hard disk drive or non-volatile memory, such as flash memory. The memory 206 may include one or more modules for implementing the functionality of the electronic device 106.

The processing device 208 can be, for example, a central processing unit (CPU), a microcontroller, or a microprocessing device, including a “general purpose” microprocessing device or a special purpose microprocessing device. The processing device 208 executes code stored in memory 206 in order to carry out operation/instructions of the electronic device 106. The processing device 208 may provide the processing capability to execute an operating system, run various applications, and provide processing for one or more of the techniques described herein.

The computer displays 210 displays information to the user such as an operating state, time, telephone numbers, various menus, application icons, pull-down menus, and the like. The computer display 210 may be used to present various images, text, graphics, or videos to the user, such as photographs, mobile television content, Internet webpages, and mobile application interfaces. The computer display 210 may be any type of suitable display, such as a liquid-crystal display (LCD), a plasma display, a light-emitting diode (LED) display, or the like.

The electronic device 106 may include audio input and output structures 212, such as a microphone for receiving audio signals from a user and/or a speaker for outputting audio signals, such as audio recordings and the like. The electronic device 106 may also include an audio port for connection to peripheral audio input and output structures, such as a headset, or peripheral speakers or microphones.

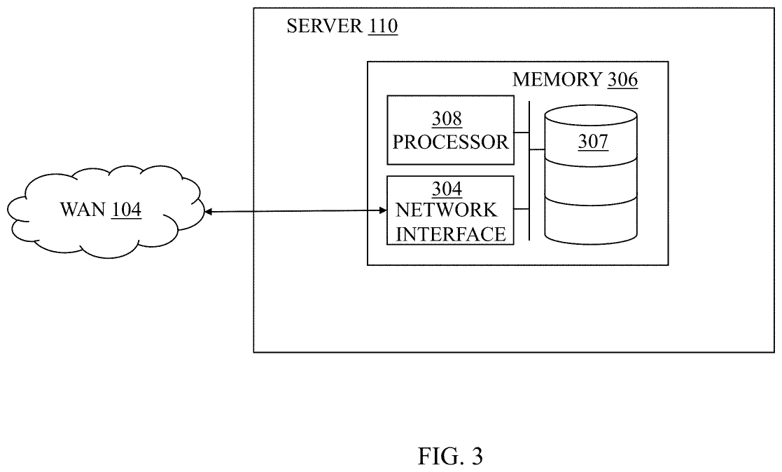

Similarly, as shown in high-level block diagram in FIG. 3, each of the servers 110₁, 110₂, 110₃, and/or 110_{N} (collectively, “server 110”) may include similar computer components to those described above. All of said components need not be repeated here. Of note, each server 110_{1-N} may be referred to herein as a database server and includes a memory 306 and at least one processor 308 that executes code stored in memory 306 operable to carry out operation/instructions of the server 110. In addition, the server 110 is coupled to a database 307 that may be considered to be a portion of the memory 306 in the server 110. Alternatively, the database 307 may be coupled to the memory 306 and processor 308 over a wireless or hard-wired connection. In an embodiment in which the database 307 is considered a remote database accessible over, for example, a long-distance network, such as the WAN 110, such communicative coupling may be via a network interface 304 on the server 110. The term “database” is intended in a broad sense to mean an organized collection of data that is stored in a non-transitory-type memory and is accessible by a processing device for utilizing the collection of data to perform computer processing tasks, and in certain embodiments may encompass a “distributed database” in a plurality of clouds and/or associated with a plurality of servers.

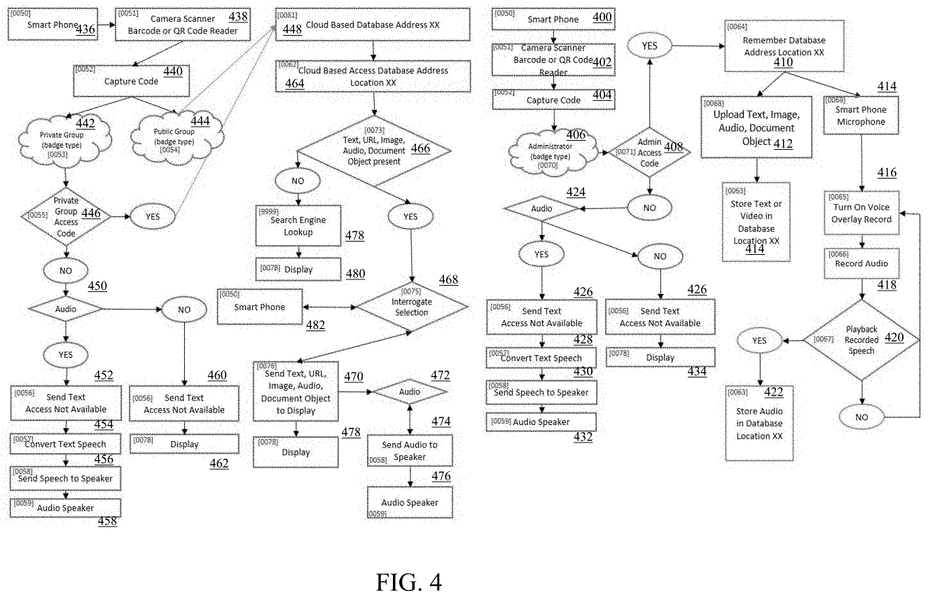

FIGS. 1-3 will now be described in conjunction with the process flow chart of FIG. 4 for a plurality of “badge types” embodied with or associated in a bar code or QR code related to a product that may be scanned by the electronic computing device 106 to obtain restricted access to product information. As described herein, access to product information is “restricted” by an administrator, and thus such access is “pre-limited” by the administrator for private and public users. The product information may be embodied as one of readable, audible and video data. The badge type, as represented in the communicated code, enables selective access to at least some or all of the product information. Although FIG. 4 depicts a specific order of executing the process steps, the order of executing the steps may be changed relative to the order shown in certain embodiments. Also, two or more blocks shown in succession may be executed concurrently or with partial concurrence in some embodiments. Certain steps may also be omitted in FIG. 4 for the sake of brevity. In some embodiments, some or all of the process steps included in FIG. 4 can be combined into a single process.

The exemplary process, depicted in FIG. 4, begins at block 400 at an electronic device 106 (e.g., a “smartphone”). Here, a user, e.g., a consumer, scans a product containing a conventional barcode or especially customizable and programable QR code via the code reader/scanner in the electronic device 106 at block 402. When implemented through the specialized and unique QR code, the QR code may be captured through a downloadable software application resident on the computing device 106. The administrative badge, in particular the code embodied therein, is captured in block 404 and communicated over the network to the administrative cloud 1021 at block 406. The server 1101 checks for, interrogates, and/or interprets the administrative badge type in block 406. If the administrative badge type is present at block 408, the process proceeds to block 410, where the badge is resolved, and the database address location XX associated with said administrative badge is remembered. From block 410, the process may proceed to block 412 where the administrator server 1101uploads at least one of text, image or audio/visual document objects communication and display to the computing device 106. This object(s) is stored in the database at database address location XX at block 414. As such, a customizable and/or programable user-experience displayed to the user. Alternatively, from block 410 the process may proceed to block 414, where the microphone of the electronic device 106 is utilized to turn on a voice overlay record (block 416) and record audio (block 418). At block 420, there is an option to playback the recorded speech and either record again at block 418, or store the recorded object in the database at block 422.

Going back to block 408, in an administrator badge is not present, the process proceeds to block 424, where a text, video, and/or audio message that access is not available may be delivered to the user's computing device 106. Specifically, a text message is sent over the communications network (block 426) to the computing electronic device 106. This message may be converted via text-to-speech (block 428), sent to the speaker of the electronic device 106 (block 430), and played over the speaker (block 432). Alternatively, at block 434 the message may be rendered on the display of the electronic device 106.

When a public or private user with an electronic device 106 (block 436) scans a barcode or QR code (blocks 438, 440), the process operates to provide restricted access to the product information as set by the administrator. In this regard, an application executing on the electronic device 106 enables the incorporation of either a public badge type or a private badge type that is communicated with the scanned barcode or QR code. The scanned code and badge type are communicated over the WAN 104 and sent either to the administrator cloud (102₁)/server 110₁, private cloud (102₂) (block 442) or public cloud (102₃) (block 444), where the codes are interpreted and/or resolved. In this regard, QR codes received from customers are resolved ultimately and/or followed to a unique URL, if provided. In one embodiment, the QR code(s) contain a URL and UUID value that uniquely identifies which administrator defined environment to visit. In other embodiments, the QR codes are resolved at the administrator server 102₁ to ascertain the database address location code, wherein, for example, the database address location code is associated with the database address location XX on an array stored in a database resident on the server 110₁.

Bar codes such as, for example, GTIN, may be sent to the administrator API. It will be appreciated that the use of GTIN is an example, and the following description is with reference to GTIN. Other expedients may be utilized within the scope of the present disclosure, such as described in https://docs.expo.io/versions/v27.0.0/sdk/bar-code-scanner, the content of which is incorporated by reference herein. The administrator software application (“App”) negotiates a secure connection to the administrator server via the Transport Security Layer (TLS) over port 443. The AWS firewall inspects all incoming traffic, blocking any traffic from the public not on port 443. The App then sends the UUID or GTIN to a specific endpoint on the administrator API over the encrypted channel. This occurs as an HTTP GET request and includes the Product UUID in the query string.

For a private user (block 442), if there is a private user access code (block 444), then access is provided to the cloud-based database address XX in the private cloud 102₂. The administrative server 102₁ may receive the encrypted HTTP GET request and use a database connection from a PostgreSQL connection pool to lookup information in the product. The administrator's API may be, in accordance with an example embodiment, constructed using Google's ogling programming language. This database connection is negotiated over TLS 1.2.

The database connection is inspected by a second AWS firewall. This firewall may block any systems not in the administrator's AWS VPN and API Security Group from connecting to the RDS server. Once the connection is established the query is allowed to execute on the Postgres database (database server 1102). Postgres executes the query using the UUID or GTIN provided from the scanned barcode. Tabular data is produced and fed back to the API over the TLS 1.2 secured channel. This information again travels through the second level firewall when it's destination is confirmed as the API Server. The administrator API database Server 102₁ receives the tabular database data and processes the information.

For a public user, Unknown GTIN codes may be directed to Google via a JSON response containing a HTTP GET request to Google at block 448, and at blocks 450 through 462 a text and/or voice via text-to-speech message is sent to the electronic device 106 to indicate “access is not available.” Thus, the public user is directed to the general Internet related sites related to the product.

Recognized GTIN requests and QR codes keep analytics and usage statistics. These statistics are incremented on each successful scan that is recognized. Recognized codes then return a new HTTP GET address for the Mobile App executing on the electronic device 106 of the private user to follow.

For authenticated private users, the Mobile App receives the JSON response and then extracts the product URL for the display and makes a HTTP GET request to that URL. Again, for unrecognized codes the Mobile App makes a request to Google for display (blocks 452-468 and 448), ending the process.

For recognized codes the request goes back to the administrator's API, and the cloud-based access database address location XX in the private cloud 102₂. In block 466, the server checks for the presence of text, URL, image(s), audio and/or a document object. As before, the client request is sent through the firewall to a specific administrator API server endpoint. This endpoint queries the production description data from AWS RDS. The returned tabular data is mapped into a JSON description of the product code, including images as links to AWS S3. ReactJS is used along with HTML, JavaScript, and CSS to render the product JSON to HTML on the server. This HTML response is then returned to the mobile app executing on the electronic device 106 over the TLS 1.2 connection. The mobile app executing on the electronic device 106 then displays any response HTML in an embedded Web View. If there are images/audio present in the database, then these are sent to the electronic device 106 (blocks 468-476). Alternatively, if there no images/audio at block 466 are present, then then a search engine lookup on the Web is displayed on the display of the electronic device 106 (blocks 478-480). At any time, the private user may interrogate a selection of desired product information (block 482, 468).

The functionality of the present disclosure may be implemented through a plurality of exemplary logical modules, where each logical module may include a set of computer instructions for executing various techniques and processes described herein. As is understood in the art, these modules may be considered to be computer programming logic modules that are executed by a processing device, such as, the processor 208 on the electronic device 106 and processor 308 on the server 110. One of ordinary skill in the art will recognize that a computer or another machine with instructions to implement the functionality of one or more logical modules is not a “general purpose” computer. Instead, the machine is adapted to implement the functionality of a particular module. Moreover, the machine embodiment of the system physically transforms the electrons representing various parts of content and data representing user interaction with the content into different content or data representing determined resonance.

The operations described herein can be performed by an apparatus which may be specially constructed for the required purposes, or it may comprise a general-purpose computer selectively activated or reconfigured by a computer program stored in the computer. A computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on one computer, partly on the computer, as a stand-alone software package, partly on the first computer and partly on a remote computer or entirely on the remote computer or server. In the latter scenario, the remote computer may be connected to the first computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

A novel and efficient computer-implemented method and system has been disclosed for enabling restricted access to product information stored in a plurality of clouds. Having thus described the disclosure of the present application in detail and by reference to embodiments thereof, it will be apparent that modifications and variations are possible without departing from the scope of the disclosure defined in the appended claims as follows:

1. A method of enabling restricted access to product information stored in a plurality of clouds, the method comprising the steps of:
storing product related information of a plurality of products on a centralized database selectively accessible by a plurality of independent clouds that includes a plurality of administrative cloud users owned by a plurality of manufacturers of at least one of the plurality of products and each with a computing device having a network interface and a private cloud user with a computing device having a network interface over a network, the product related information uploaded and selectively customizable and programable for pre-limited access rights by each of the plurality of administrative cloud users to be visually perceived in an administrator defined user-interface environment over a unique URL and a unique UUID value that is associated with a database address location code for each one of the plurality of administrative cloud users;
executing a software applicable on the computing device of the private cloud user and communicatively coupling the computing device of the private cloud user with the centralized database:
scanning, with a transducer on the computing device of the private cloud user, at least one of a QR code and a barcode located on the product, the at least one of a QR code and a barcode located on the product having a private badge associated therewith and including the unique UUID value;
receiving, at the centralized database and from the computing device of the private cloud user, a request for product related information, the request including the database address location code from the unique UUID value;
accessing, by a server, product related information visually displayable on the unique URL; and
sending, by the server, the restricted product related information with the pre-limited access rights to the computing device of the private cloud user for an HTTP GET request involving the unique URL associated with the database address location of the product of one of the plurality of administrative cloud users.

2. (canceled)

3. The method in accordance with claim 1, wherein the barcode represents one of a public badge type and a private badge type corresponding to the pre-limited access rights.

4. The method in accordance with claim 1, wherein the code is a QR code representing one of a public badge type and a private badge type corresponding to the pre-limited access rights.

5. (canceled)

6. The method in accordance with claim 1, wherein each of the plurality of clouds includes a corresponding database having a cloud-based database address.

7. The method in accordance with claim 1, wherein the pre-limited access rights are set by the administrator via an electronic device.

8. The method in accordance with claim 1, wherein the product information comprises at least one of readable, audible and video data.

9. The method in accordance with claim 1, wherein a scanned code representing a public badge type is sent to a first database address.

10. The method in accordance with claim 1, wherein a scanned code representing a private badge type is sent to a second database address.

11. A system for enabling restricted access to product information stored in a plurality of clouds, the system comprising:
at least one centralized database for storing product related information selectively accessible by a plurality of independent clouds that includes a plurality of administrative cloud users owned by a plurality of manufacturers of at least one of the plurality of products and each with a computing device having a network interface and a private cloud user with a computing device having a network interface over a network, the product related information uploaded and selectively customizable and programable for pre-limited access rights by each of the plurality of administrative cloud users to be visually perceived in an administrator defined user-interface environment over a unique URL and a unique UUID value that is associated with a database address location code for each one of the plurality of administrative cloud users;
a server coupled to a communication network and having a non-transitory memory, at least one processor, and having a set of computer program instructions stored in the non-transitory memory and executable by the at least one processor, the set of computer instructions including instructions for:
receiving, at the server, a request for product related information, the request including the database address location code from the unique UUID value;
accessing, by the server, product related information visually displayable on the unique URL; and
sending, by the server, the product related information with the pre-limited access rights to the computing electronic device of the private cloud user for an HTTP GET request involving the unique URL associated with the database address location of the product of one of the plurality of administrative cloud users.

12. (canceled)

13. The system in accordance with claim 11, wherein the at least one code is a barcode representing one of a public badge type or a private badge type corresponding to the pre-limited access rights.

14. The system in accordance with claim 11, wherein the at least one code is a QR code representing one of a public badge type or a private badge type corresponding to the pre-limited access rights.

15. The system in accordance with claim 11, wherein the plurality of clouds respectively correspond to a private user, a public user, and an administrator.

16. The system in accordance with claim 15, wherein each of the plurality of clouds includes a corresponding database having a cloud-based database address.

17. The system in accordance with claim 15, wherein the pre-limited access rights are set by the administrator via an electronic device.

18. The system in accordance with claim 15, wherein the product information comprises at least one of readable, audible and video data.

19. The system in accordance with claim 11, wherein a scanned code representing a public badge type is sent to a first database address.

20. The system in accordance with claim 11, wherein a scanned code representing a private badge type is sent to a second database address.
